(19) United States
(12) Patent Application Publication
(10) Pub. No.: US 2011/0223880 A1
(43) Pub. Date: Sep. 15, 2011

(54) Optimized Predictive Emergency Notification for Vehicles While in No Cellular Coverage Area

(75) Inventors: Yervant David Lepejian, Sunnyvale, CA (US); Gurgon Levoni Lachinyan, Palo Alto, CA (US); Scott Nisbet, Berkeley, CA (US)

(73) Assignee: SOSY TECHNOLOGIES STU, INC., Santa Clara, CA (US)

(21) Appl. No.: 13/039,064

(22) Filed: Mar. 2, 2011

Related U.S. Application Data
(60) Provisional application No. 61/339,239, filed on Mar. 2, 2010.

(51) Int. Cl. H04M 11/04

(52) U.S. Cl. 455/404.2

(57) ABSTRACT

A method and system for predictive emergency notification of a vehicle passing through a dark coverage area (DCA). The method comprises continuously monitoring at least speed and position of the vehicle; monitoring available cellular tower signal strength indicators to predict entrance into a DCA; comparing said position of the vehicle with information about boundaries of DCAs to determine whether the vehicle is about to enter the DCA; calculating a lapsed time for the vehicle to emerge from the DCA, wherein the lapsed time calculated using at least one of an entry point to the DCA, an exit point from the DCA, and an average speed of the vehicle; tracking the vehicle and the lapsed time to ensure that the vehicle is out of the DCA within the lapsed time; and notifying of a possible emergency if the vehicle has not emerged from the DCA within the lapsed time.

### CROSS-REFERENCE TO RELATED APPLICATIONS

This application claims the benefit of U.S. Provisional Application No. 61/339,239, filed Mar. 2, 2010, which is hereby incorporated by reference for all that it contains.

### TECHNICAL FIELD

The invention relates to providing emergency notification for vehicles, and more specifically to providing coverage for emergency notification in areas where only partial or no cellular phone coverage exists.

### BACKGROUND OF THE INVENTION

Typically, emergency notification and accident notification of vehicles is accomplished by establishing a connection from a cellular phone through a cellular network. Typically, it is handled as a manually activated notification process. In the related art, solutions for providing automated coverage of the emergency notification have been developed. This type of a notification requires an access to a cellular network in the area where the emergency occurs. Solutions have also been developed for automating the emergency notification where the cellular coverage is available.

However, there is not current solution to solve the problems of the inability of the notification systems to provide emergency notifications in areas where wireless (e.g., cellular) coverage does not exist.

### SUMMARY OF THE INVENTION

Certain embodiments of the invention include a method for predictive emergency notification of a vehicle passing through a dark coverage area (DCA). The method comprises continuously monitoring at least speed and position of the vehicle; monitoring available cellular tower signal strength indicators to predict entrance into a DCA; comparing said position of the vehicle with information about boundaries of DCAs to determine whether the vehicle is about to enter the DCA; calculating a lapsed time for the vehicle to emerge from the DCA, wherein the lapsed time calculated using at least one of an entry point to the DCA, an exit point from the DCA, and an average speed of the vehicle; tracking the vehicle and the lapsed time to ensure that the vehicle is out of the DCA within the lapsed time; and notifying of a possible emergency if the vehicle has not emerged from the DCA within the lapsed time.

### BRIEF DESCRIPTION OF THE DRAWINGS

The subject matter that is regarded as the invention is particularly pointed out and distinctly claimed in the claims at the conclusion of the specification. The foregoing and other features and advantages of the invention will be apparent from the following detailed description taken in conjunction with the accompanying drawings.

FIG. 1 is a schematic diagram representing a vehicle transferring into an area of no cellular wireless coverage, that is a dark coverage area (DCA) from a cellular wireless covered area (WCA) and the re-emergence into a second WCA.

FIG. 2 is a flowchart of a method enabling an emergency notification in DCAs according to an embodiment of the invention.

FIG. 3 is a block diagram of a monitoring system used to achieve the emergency notification according to an embodiment of the invention.

FIG. 4 is a block diagram of a monitoring device designed according to an embodiment of the invention.

### DETAILED DESCRIPTION OF THE INVENTION

It is important to note that the embodiments disclosed by the invention are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

In an embodiment of the invention, a vehicle monitoring system allowing predictive emergency notification in areas of no cellular coverage is provided. The system predicts the possible imminent entry to a Dark Coverage Area (DCA) and estimates exit times from the DCA. With GPS and cellular towers signaling reception and continuous contact to a central monitoring system, the speed and position of the vehicle is also monitored. The vehicle monitoring system having access to the non-coverage areas of cell phone operators and predicted cellular tower signal strength, notifies, after a period of lapsed time, if a vehicle has not emerged from a DCA, so that emergency action can be initiated. In an embodiment of the invention, the initiation of emergency action can be applied on an enablement basis when the customer requests it.

As will be described in detail below, the vehicle monitoring system includes a monitoring device installed in the vehicle and is typically connected to an on-board diagnostic (OBD) port. In another embodiment of the invention, the monitoring device is a separate location aware device, such as, but not limited to, a cellular phone having a built-in global positioning system (GPS), a cellular connected personal navigation device (PNR), or the like.

The monitoring device is used for tracking the location of the vehicle and for monitoring the travel speed and position of the vehicle using the GPS and cellular connection signals. The vehicle monitoring system predicts the non-coverage areas of cellular phone operators, and notifies, after a period of a lapsed time, if a vehicle has not emerged from an area of no cell coverage, so that emergency action can be initiated in case of an emergency. In addition, the last known location can also be stored for later emergency reference. The emergency action initiation can be applied on an enablement basis when the customer requests it.

In an embodiment of the invention, the monitoring device is connected to the OBD port of a vehicle or other power source in the vehicle. This monitoring device is in communication with GPS signals, the cellular base station towers, and the driver of the vehicle through his cellular phone and/or the vehicle's internal communication system. An example for a monitoring device and its operation is described in detail the co-pending US Patent Application Publication Number 2009/0112394 to Lepejian, et al. entitled “Apparatus for Collecting, Storing and Transmitting Vehicle Information”, assigned to common assignee, and that is herein incorporated by reference for all that it contains.

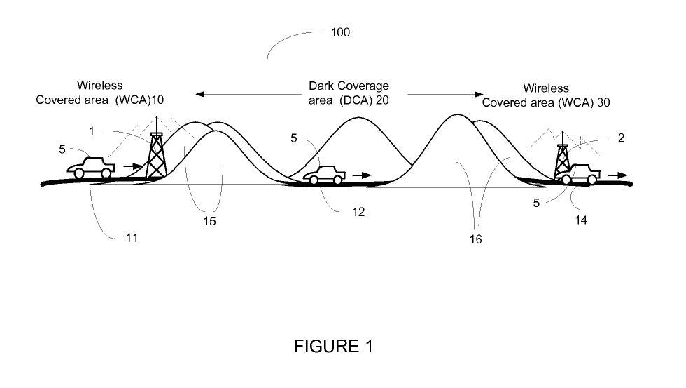

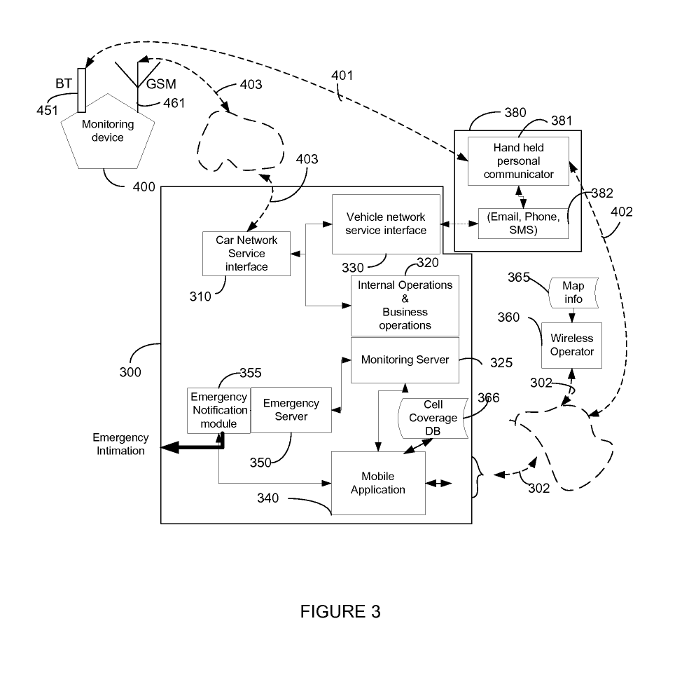

For most geographic areas, cellular network operators provide coverage databases (e.g., a database 365 shown in FIG. 3) that lists the basic cellular coverage in a specific area. Each operator tries to provide the best coverage possible, using a limited number of wireless backhaul towers (WBT) available to the operator. According to another embodiment of the invention, the vehicle monitoring system predicts the cellular coverage area to establish the location of areas where the cell coverage is not available, designated as dark coverage areas (DCA), as well as wireless coverage areas (WCA). FIG. 1 shows a vehicle 5 traveling along a road covering locations 11, 12, and 14.

The monitoring device, using its GPS connection and cellular connection, collects and updates the boundaries of the available cellular network coverage via tower signal strength and other criteria. The device integrates the collected information with the available information from the coverage databases to provide more accurate boundaries of the DCAs. In addition, the capability to identify the location of available towers within a coverage area exists when using this system. This information can be used to improve the reliability of coverage databases used for providing coverage over and above the available maps, from wireless operators and third party suppliers. The collected information is also compiled for updating the coverage databases. The compiled information is also used for updating available coverage information and evaluating the predictive accuracy of the current monitoring device and system.

Information in the coverage databases can be effectively used to define the DCA and WCA for the purpose of providing emergency coverage for a vehicle passing from a WCA into the DCA. The decreasing tower signal strength indicates that a vehicle is moving away from the tower (e.g., driving from a location 11 to a location 12 shown in FIG. 1) and an increasing tower signal strength indicates a vehicle moving towards the signal source (e.g., driving from a location 12 to a location 14 shown in FIG. 1). If a vehicle is moving in a WCA some signals will reduce in strength while others will increase. But when the vehicle moves closer to a DCA (e.g., location 12), there will not be an increasing signal. The only signal that is present will be the signal with reducing strength. Such a signal, if available, predicts the approach or arrival of the vehicle to a DCA and can trigger a location notification to the central server database before coverage is not longer available. It should be noted that this information can be also used to enhance accuracy of the coverage databases and to allow new or unrecognized DCAs to be predicted prior to entry.

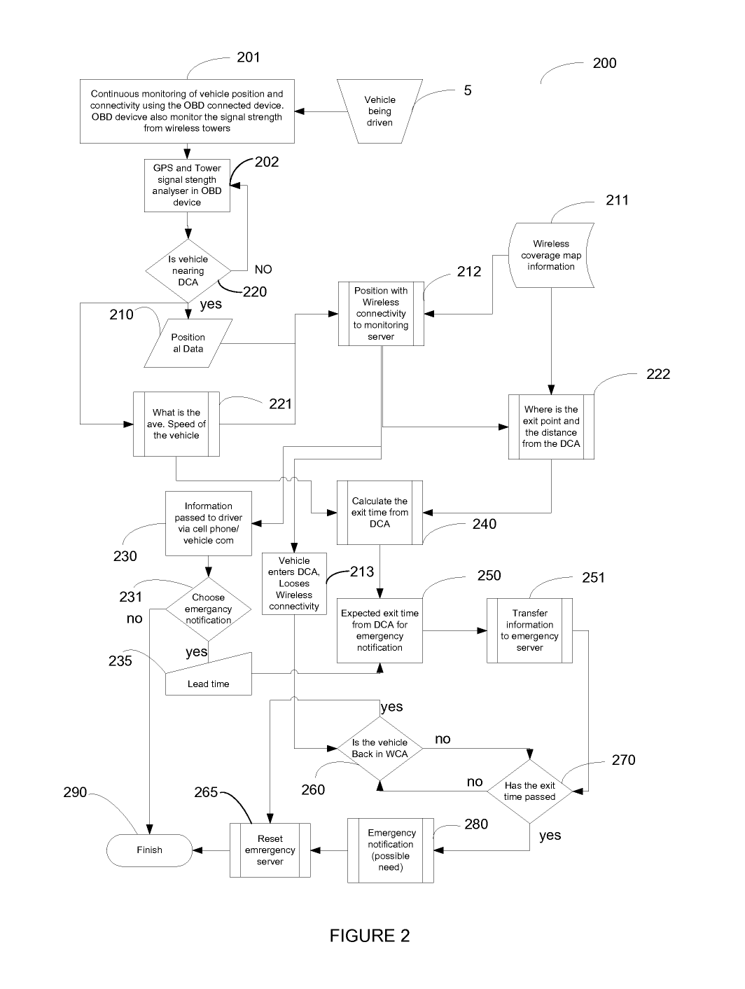

FIG. 2 shows an exemplary and non-limiting flowchart 200 illustrating a method of a predictive emergency notification implemented in accordance with an embodiment of the invention. The method will be described with reference to FIG. 1.

Location 11 is a road in a WCA designated as a wireless coverage area (WCA) 10 with a wireless coverage provided by the WBT 1. The position of the vehicle 5, the wireless coverage, and other functions of the vehicle 5, are continuously monitored, in 201, by the monitoring device. As the vehicle nears the DCA region 20, the wireless coverage provided by the WBT 1, is limited, e.g., by the presence of the mountainous regions 15. Hence, there is a DCA 20 on the other side of the mountainous region 15. While the vehicle 5 is in operation, the GPS and tower strength analysis in 202 is used to determine if the vehicle 5 is about to enter a DCA. If so, the monitoring device collects information of the vehicle 5's position, in 210, and speed, in 221. Thereafter, in 212, the device provides the speed and position information to a central monitoring server.

In 222, the monitoring server extracts the information on the exit point distance from the DCA 20 entry point. This is used with the average speed of the vehicle in 221 to determine the time of transit of the DCA 20 in 240. Typically, in 230, the information that the vehicle 5 is entering the DCA 20 is also passed to the driver by the monitoring server. In 231, the driver has the option to choose to use or not use the emergency notification facility. If the driver chooses to have the notification, then a lead-time may be supplied by the driver in 235. This time is added to the exit time (lapsed time) calculated in 240 to determine the time acceptable before the notification of possible emergency in 250. Alternately, a percentage of the total calculated travel time can be added to the calculated time of exit as a lead-time to determine the acceptable time lapse before notification. This addition of a lead-time is to prevent premature emergency notification to the emergency analyst, and support agencies. This can happen due to the vehicle being driven at a slower speed or due to congestion on the roads. The final value of time acceptable is then passed on to an emergency server, in 251.

Once the vehicle 5 is in the DCA 20, e.g., at location 12, the emergency server continuously monitors the exit status of the vehicle to determine if it is out of the DCA 20, in 260. In 270, the emergency server also monitors the delay time, to determine if the delay has not exceeded a predefined time period. If the vehicle 5, exits the DCA 20 into the WCA 30, the vehicle 5 is then back in a WCA with a cellular network coverage provided by WBT 2. In 265, the vehicle exits the DCA 20 before the delay time is exceeded, and the emergency server resets itself as indicated in 265.

If, on the other hand, the vehicle 5 has not exited the DCA 20 within the acceptable time, the emergency notification of a possible emergency in the DCA is sent in 280 to the emergency analyst, and support agencies. The lapsed time and the lead time may be preconfigured by the operator of the monitoring system. These time periods may be set to different values in different locations.

The capability of providing emergency notification allows reducing the anxiety of parents when their teenaged children take the vehicles out by themselves, or in general, a supervisor wishing to supervise a vehicle. In this case, the supervisor has the ability to activate the emergency notification capability before the vehicle is handed over to another driver. The supervisor can also be added to the notification group at that time through the phone. The driver of the vehicle can be notified when about to enter a DCA, but does not have the choice of enabling or disabling the notification function. Typically, the lead-time in such cases is set to be a percentage of the calculated time of transit through the DCA. If the time acceptable is exceeded, notification of a possible emergency can be provided to the emergency and support agencies and the supervisor can be notified at the same time.

It should be noted that having this capability can help reduce some of the parental anxiety when children are out of contact and can be involved in an emergency situation while driving. If for any reason, the driver wants to stop in a DCA then an option to contact the parent, or supervisor for that matter, to disable the notification feature or increase the lead-time for that instance prior to the entry of the vehicle into the DCA exists. There can also be an option to simply record when and where a vehicle went into a DCA without predicting an exit time. This more passive use of the system could cut down false alarms, but still be valuable in finding lost vehicles if they were later determined to be missing.

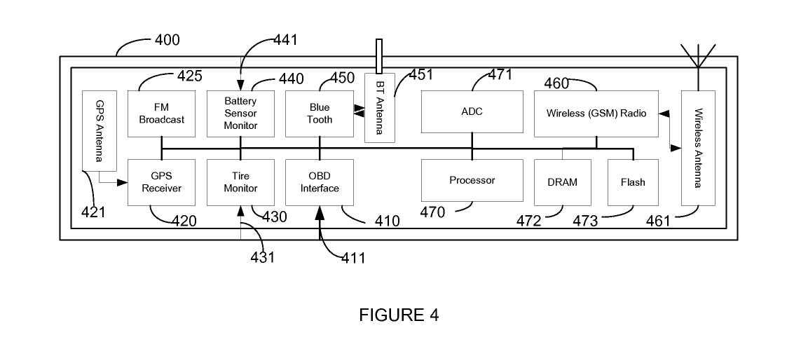

FIG. 3 shows an exemplary and non-limiting block diagram of the vehicle monitoring system 300 implemented according to an embodiment of the invention. The system 300 generates predictive emergency notifications of vehicles that include a monitoring device 400. An exemplary and non-limiting block diagram of a monitoring device 400 implemented according to an embodiment of the invention is shown in FIG. 4.

The monitoring device 400 is connected to an OBD port 411 of the vehicle. The monitoring device 400 is used for continuously monitoring the status of the vehicle including speed of the vehicle and its location. The location of the vehicle is monitored using a GPS 420 or other location-identifying receivers built into the monitoring device 400.

The monitoring device 400 is in contact with a vehicle monitoring system 300 that is external to the vehicle, through wireless connectivity 303 from the monitoring device 400. Similarly, the monitoring device 400 is connected via Bluetooth connectivity 301 to the personal hand held device 380 of the driver where available. The monitoring device 400 is also connected to the vehicle's internal radio system.

The monitoring device 400 further comprises a GPS receiver 420, with a built-in GPS antenna 421, to determine the location of the vehicle, a tire monitoring unit 430 that receives an input 431 from sensors in the tires of the vehicle to monitor at least the tire pressure and temperature, a battery sensor monitoring circuit 440 to continuously monitor the battery performance and conditions through the battery connection 441, and a Bluetooth transceiver 450 with an antenna 451, to communicate information and status directly with, for example, cell phones of the operator of the vehicle. This also allows monitoring device 400 to profile the operator and enables possible limiting conditions to be imposed on the operation of the vehicle if so desired.

In addition, the device 400 includes a FM broadcast transmitter 425 that connects to the vehicle's radio for hands-free voice and status communication during vehicle operation. The device 400 further provides for connectivity to an external wireless network through a radio transceiver 460 with an integrated antenna 461. The external wireless connectivity is used to monitor the condition of the vehicle, the location of the vehicle, its operational status and the profile of the operator on a semi-continuous basis and provides the vehicle owner with necessary service warnings through short message service (SMS), email or cell phone gateways if and when detected. The sensory inputs and the communication inputs and outputs are processed by the device 440 using a processor 170 and analog-to-digital converter (ADC) circuits 471. The sensory and communication inputs are stored in a DRAM 472 during processing and then in a non-volatile memory such as a Flash memory 473 for future read back and analysis, prior to being sent out to the external wireless net.

Referring back to FIG. 3, the information collected by the monitoring device 400 is transferred to the vehicle monitoring system 300 on a continuous basis or on-demand through the car network service interface 310. This information is sent to the monitoring server 325 which is part of the business and internal operations unit 320 which checks the details of the vehicle and if acceptable keeps track of the vehicle status. The vehicle position and speed information is also passed on to the monitoring server 325. The monitoring server 325 also has an access to one or more wireless operators 360, through a mobile application unit 340 via a communication link 302. This provides the monitoring server 325 access to wireless coverage information and mobile wireless operators' database 365 that lists geographical areas of DCAs and WCAs.

During operation of the system the monitoring server 325 collects, stores, and uses additional information, such as cellular tower signal strength indicators, the data stored in the coverage database 366 and database 365, for improving the reliability of predicted coverage.

As the monitoring server 325 recognizes from the vehicle position and direction, that the vehicle is about to enter a DCA, or as the device predicts that the cellular tower signal strength is about to disappear, (thus entering a DCA), the server 325 identifies the exit from DCA. The monitoring server 325 then checks the distance the vehicle has to transit in the DCA from the map information available. This distance information is used with an average vehicle speed to arrive at a lapsed time for exit from the DCA. The monitoring server 325 provides intimation of the move of the vehicle from WCA to DCA to the driver of the vehicle via the Bluetooth connected phone. It can also provide the information to the owner of the vehicle, if such a request has been programmed in previously, via the mobile application communication link.

The generated information is sent to a connected emergency server 350 which takes over the monitoring of the status of the vehicle and the lapsed (delay/acceptable) time. Typically, a lead-time supplied by the driver or calculated as a percentage of the lapsed time is added to the calculated lapsed time by the emergency server 350 to arrive at a new lapsed time for the vehicle from the DCA. Once the vehicle enters the DCA and a wireless connection with the vehicle is lost, the lapsed time counts down. The vehicle typically using an identification (ID) number of a monitoring device is monitored to determine when and if the vehicle exits the DCA into the next WCA during this period. If the vehicle has exited the DCA and the wireless connection has been re-established prior to the time the lapsed time counts down to zero, the emergency server 350 resets itself and no notification action is initiated.

If the lapsed time counts down to zero and the vehicle has not exited the DCA and no wireless contact has been established, the emergency server 350 initiates the emergency notification process. Through a communication link in a notification module 355, associated with the emergency server 350, intimation is sent of possible emergency in the DCA to the service and emergency agencies. The emergency server 350 may also send notification to the vehicle's owner via the mobile application link 340 of the vehicle monitoring system 300.

As discussed earlier, the DCA information is continuously updated and stored in a map database 365. The database 365 provides the additional information for reliable coverage over and above what exists from the map information available through the wireless operators and third party suppliers.

The principles of the invention are implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit. All or some of the servers maybe combined into one or more integrated servers. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for predictive emergency notification of a vehicle passing through a dark coverage area (DCA), comprising:
continuously monitoring at least speed and position of the vehicle;
monitoring available cellular tower signal strength indicators to predict entrance into a DCA;
comparing said position of the vehicle with information about boundaries of DCAs to determine whether the vehicle is about to enter the DCA;
calculating a lapsed time for the vehicle to emerge from the DCA, wherein the lapsed time calculated using at least one of an entry point to the DCA, an exit point from the DCA, and an average speed of the vehicle;
tracking the vehicle and the lapsed time to ensure that the vehicle is out of the DCA within the lapsed time; and
notifying of a possible emergency if the vehicle has not emerged from the DCA within the lapsed time.

2. The method of claim 1, further comprising:
informing a driver of the vehicle of the entry of the vehicle into the DCA to provide the driver a choice of at least one of: storing DCA entry information for later retrieval if the vehicle is later considered missing, activating a predictive emergency notification capability, and disabling the predictive emergency notification capability.

3. The method of claim 2, wherein tracking of the vehicle and notifying of the possible emergency are performed if the driver activates the predictive emergency notification.

4. The method of claim 1, further comprising:
resetting said tracking of the vehicle as the vehicle emerged from the DCA within the limitation of the lapsed time.

5. The method of claim 1, wherein the continuously monitoring of the at least speed, and the position of the vehicle is performed using a monitoring device, wherein the monitoring device is connected to an on-board diagnostic (OBD) port of the vehicle.

6. The method of claim 1, further comprising:
using a location aware device with cellular phone connectivity for continuously monitoring the at least speed and the position of the vehicle.

7. The method of claim 5, further comprising at least one of:
establishing a connection between the monitoring device and a central server via a wireless connection;
establishing a connection between the monitoring device and a global positioning system (GPS); and
establishing a connection between the monitoring device and a cellular network.

8. The method of claim 1, further comprising:
adding a lead time to the lapsed time resulting in a longer lapsed time.

9. The method of claim 7, wherein the lead time is achieved by any one of:
receiving said lead time from the driver; and calculating said lead time as a percentage of said lapsed time.

10. The method of claim 1, wherein the lapsed time is used to prevent inadvertent possible notification.

11. A method for generating predictive emergency notification regarding a vehicle passing through a dark coverage area (DCA) comprising:
enabling a supervisor to activate a predictive emergency notification capability for tracking the vehicle;
continuously monitoring at least speed and position of the vehicle using at least a global positioning system (GPS) locator in a monitoring device installed in the vehicle;
comparing a location of the vehicle with locations of cellular towers and signal strength indicators for predicting an entry into DCA, wherein the DCA is an area without wireless coverage;
comparing the position of the vehicle with information containing the boundaries of DCAs to determine whether the vehicle is about to enter the DCA;
calculating a lapsed time for the vehicle to emerge from the DCA, wherein the lapsed time calculated using at least one of an entry point to the DCA, an exit point from the DCA, and an average speed of the vehicle;
tracking the vehicle and the lapsed time to ensure that the vehicle is out of the DCA within said lapsed time;
notifying at least one of the supervisor and a emergency analyst, of a possible emergency if the lapsed time for exit of the vehicle from the DCA is exceeded.

12. The method of claim 11, the continuously monitoring of the at least speed, and the position of the vehicle is performed using a monitoring device, wherein the monitoring device is connected to an on-board diagnostic (OBD) port of the vehicle.

13. The method of claim 11, further comprising:
using a location aware device with cellular phone connectivity for continuously monitoring the at least speed and the position of the vehicle.

14. The method claim 12, further comprising:
establishing a connection between the monitoring device and a central server via a wireless connection;
establishing a connection between said monitoring device and a global positioning system (GPS); and
establishing a connection between said monitoring device and a cellular network.

15. The method claim 13, further comprising:
establishing a connection between the location aware device and a central server via a wireless connection;
establishing a connection between the location aware device and a global positioning system (GPS); and
establishing a connection between said location aware device and a cellular network.

16. The method of claim 11, further comprising:
adding a lead time to the lapsed time resulting in a longer lapsed time.

17. The method of claim 11, wherein said lapsed time is used to prevent inadvertent possible emergency notification to at least one of the supervisor, the emergency, analyst and support agencies.

18. A system for proving notification of a possible emergency of a vehicle in a dark connection area (DCA) comprising:
a monitoring device for collecting at least position and speed information of the vehicle;
a monitoring server for receiving the collected information from the monitoring device and for performing:
predicting entry into a DCA using at least locations of cellular towers and signal strength indicators;
determining a possible entry location of the vehicle into the DCA and a possible exit location from the DCA;
calculating a lapsed time for the vehicle to emerge from the DCA, wherein the lapsed time calculated using at least one of an entry point to the DCA, an exit point from the DCA, and an average speed of the vehicle;
tracking the lapsed time and the status of the vehicle to ensure that the vehicle has exited into the WCA at the end of the lapsed time; and
emergency server for generating and sending emergency notifications in an event of the vehicle not exiting the DCA within the lapsed time.

19. The system in claim 18, wherein the monitoring device is connected to the on board diagnostic (OBD) port of the vehicle.

20. The system in claim 18, wherein the said monitoring device is a location aware device with cellular phone connectivity.
